(19) United States
(12) Patent Application Publication
(10) Pub. No.: US 2017/0170614 A1
(43) Pub. Date: Jun. 15, 2017

(54) ADAPTER ASSEMBLY

(71) Applicant: SAMSUNG ELECTRONICS CO., LTD., Suwon-si (KR)

(72) Inventors: Tae-Jun YOU, Suwon-si (KR); Seong Ho PARK, Hwaseong-si (KR); Won Myung WOO, Seoul (KR); Ji Won LEE, Hwaseong-si (KR); Sang Il JUNG, Jeonju-si (KR)

(73) Assignee: SAMSUNG ELECTRONICS CO., LTD., Suwon-si (KR)

(21) Appl. No.: 15/283,996

(22) Filed: Oct. 3, 2016

Related U.S. Application Data
(60) Provisional application No. 62/265,524, filed on Dec. 10, 2015.

(30) Foreign Application Priority Data
Jan. 25, 2016 (KR) 10-2016-0008550

(51) Int. Cl. H01R 24/76; H01R 13/506; H01R 31/06

(52) U.S. Cl. CPC H01R 24/76; H01R 31/06; H01R 13/506; H01R 2103/00

(57) ABSTRACT

An adapter assembly detachably coupled to a plug through a locking structure includes an adapter configured to include connection pins, a plug configured to include a terminal contacting the connection pins and a locking structure through which the plug and the adapter are detachably fixed to each other.

### CROSS-REFERENCE TO RELATED APPLICATION(S)

This application claims the benefit of Korean Patent Application No. 10-2016-0008550, filed on Jan. 25, 2016 in the Korean Intellectual Property Office, the disclosure of which is incorporated herein by reference in its entirety.

This application also claims the benefit of U.S. Provisional Application Ser. No. 62/265,524, filed on Dec. 10, 2015, the contents of which are hereby incorporated by reference in their entirety.

### BACKGROUND

1. Field

Embodiments of the present disclosure relate to an adapter assembly, and more particularly to an adapter assembly detachably coupled to a plug through a locking structure.

2. Description of the Related Art

Generally, electronic appliances are designed to use different voltages according to categories and usages thereof, and input units configured to receive power supply are designed in different shapes according to respective products.

Therefore, in order to power the electronic appliance on, a power-supply voltage appropriate for the electronic appliance must be supplied to the electronic appliance through a connector having a specific shape appropriate for an input unit of the electronic appliance. In order to perform the above-mentioned function, a power-supply adapter acting as a power conversion supply device is designed.

Specifically, the power-supply adapter has been widely used as the power conversion supply device for converting AC power into DC power and providing the DC power to various electronic appliances (e.g., laptops, Personal Computers (PCs), displays, mobile phones, etc.) designed to use DC power. In addition, the power-supply adapter may charge a battery with electricity, and may provide a power-supply voltage needed to drive the electronic appliance, thereby generating an output power-supply voltage upon receiving the input power-supply voltage.

The power-supply adapter includes a plug connected to a power socket and a connector connected to the electronic appliance in a main body in which the AC/DC conversion and transform circuit is embedded, such that high-voltage AC power received through the power socket is converted into an appropriate-voltage DC power, and the DC power is then applied to the electronic appliance.

### SUMMARY

Therefore, it is an aspect of the present disclosure to provide an adapter assembly including a detachable plug therein.

It is another aspect of the present disclosure to provide an adapter assembly detachably connected through a locking structure.

It is another aspect of the present disclosure to provide an adapter assembly for allowing a plug to be strongly combined with an adapter through a simple structure.

Additional aspects of the present disclosure will be set forth in part in the description which follows and, in part, will be obvious from the description, or may be learned by practice of the present disclosure.

In accordance with an aspect of the present disclosure, an adapter assembly includes an adapter configured to include connection pins, a plug configured to include a terminal contacting the connection pins and a locking structure through which the plug and the adapter are detachably fixed to each other.

The locking structure may include a first locking portion disposed in the plug and a second locking portion disposed in the adapter and detachably coupled to the first locking portion.

The second locking portion may include a through hole disposed in at least one of the connection pins.

The first locking portion may include an elastic piece disposed in the terminal and configured to generate elastic force when the connection pins move in a manner that the elastic piece is coupled to the groove.

The first locking portion may include a button portion disposed in the plug and a moving portion configured to move by the button portion so that the moving portion is coupled to or separated from the connection pins.

The first locking portion may include a rotation bar configured to rotate by the plug and a rotation protrusion coupled to or separated from the adapter by rotation of the rotation bar.

The first locking portion may include a protrusion protruding from a bottom surface of the plug and the protrusion may include at least one of a spherical shape, a diamond shape, a square shape, a triangular shape, and a semicircular shape.

The second locking portion may include a groove formed in a shape corresponding to the protrusion.

The first locking portion may include a separation portion disposed in a center part of the protrusion in a manner that the first locking portion is elastically coupled to the second locking portion.

In accordance with another aspect of the present disclosure, an adapter assembly includes a plug, an adapter main body in which connection pins coupled to the plug are disposed, and a locking structure through which the plug and the adapter are detachably coupled to each other, wherein the locking structure includes a first locking portion disposed in the plug, and a second locking portion disposed in at least one of the adapter main body and the contact pins in a manner that the second locking portion is fixed and separated by the first locking portion.

The second locking portion may include a through hole disposed in at least one of the connection pins.

The first locking portion may include an elastic piece disposed in the terminal and configured to generate elastic force when the connection pins move in a manner that the elastic piece is coupled to a groove.

The first locking portion may include a button portion disposed in the plug, and a moving portion configured to move by the button portion so that the moving portion is coupled to or separated from the connection pins.

The first locking portion may include a rotation bar configured to rotate by the plug, and a rotation protrusion coupled to or separated from the adapter by rotation of the rotation bar.

The first locking portion may include a protrusion protruding from the plug, and the protrusion includes at least one of a spherical shape, a diamond shape, a square shape, a triangular shape, and a semicircular shape.

The second locking portion may include a groove formed in a shape corresponding to the protrusion.

The first locking portion may include a separation portion disposed in a center part of the protrusion in a manner that the first locking portion is elastically coupled to the second locking portion.

The first locking portion may include an elastic support hole passing through the protrusion.

### BRIEF DESCRIPTION OF THE DRAWINGS

These and/or other aspects of the present disclosure will become apparent and more readily appreciated from the following description of the embodiments, taken in conjunction with the accompanying drawings of which:

FIG. 1 is a view illustrating a plug and an adapter according to a first embodiment of the present disclosure.

FIG. 2 is an exploded perspective view illustrating the plug detachably coupled to the adapter according to the first embodiment of the present disclosure.

FIG. 3 is a partial cross-sectional view illustrating a locking structure between the plug and the adapter according to the first embodiment of the present disclosure.

FIG. 4 is a view illustrating a locking structure between the plug and the adapter according to the first embodiment of the present disclosure.

FIG. 5 is a view illustrating a plug and an adapter according to a second embodiment of the present disclosure.

FIG. 6 is an exploded perspective view illustrating a locking structure for allowing the plug to be detachably coupled to the adapter according to the second embodiment of the present disclosure.

FIG. 7 is a perspective view illustrating an adapter coupled to the plug according to the second embodiment of the present disclosure.

FIGS. 8 and 9 are views illustrating an adapter coupled to the plug by the locking structure according to the second embodiment of the present disclosure.

FIG. 10 is a cross-sectional view illustrating the plug and adapter coupled to each other by the locking structure according to the second embodiment of the present disclosure.

FIGS. 11 and 12 are views illustrating the plug separated from the adapter by the locking structure according to the second embodiment of the present disclosure.

FIG. 13 is a view illustrating a locking structure between the plug and the adapter according to a third embodiment of the present disclosure.

FIG. 14 is a perspective view illustrating a first locking portion of the plug according to the third embodiment of the present disclosure.

FIG. 15 is a view illustrating connection between the first locking portion and the second locking portion of the locking structure according to the third embodiment of the present disclosure.

FIG. 16 is a view illustrating a locking structure according to a fourth embodiment of the present disclosure.

FIG. 17 is a view illustrating a first locking portion of the locking structure according to the fourth embodiment of the present disclosure.

FIG. 18 is a view illustrating connection between the first locking portion and the second locking portion of the locking structure according to the fourth embodiment of the present disclosure.

FIG. 19 is a view illustrating a locking structure according to a fifth embodiment of the present disclosure.

FIG. 20 is a view illustrating a first locking portion of the locking structure according to the fifth embodiment of the present disclosure.

FIG. 21 is a view illustrating connection between the first locking portion and the second locking portion of the locking structure according to the fifth embodiment of the present disclosure.

FIG. 22 is a view illustrating a locking structure according to a sixth embodiment of the present disclosure.

FIG. 23 is a view illustrating a first locking portion of the locking structure according to the sixth embodiment of the present disclosure.

FIG. 24 is a view illustrating connection between the first locking portion and the second locking portion of the locking structure according to the sixth embodiment of the present disclosure.

FIG. 25 is a view illustrating a locking structure according to a seventh embodiment of the present disclosure.

FIG. 26 is a view illustrating a first locking portion of the locking structure according to the seventh embodiment of the present disclosure.

FIG. 27 is a view illustrating connection between the first locking portion and the second locking portion of the locking structure according to the seventh embodiment of the present disclosure.

### DETAILED DESCRIPTION

Reference will now be made in detail to the embodiments of the present disclosure, examples of which are illustrated in the accompanying drawings, wherein like reference numerals refer to like elements throughout.

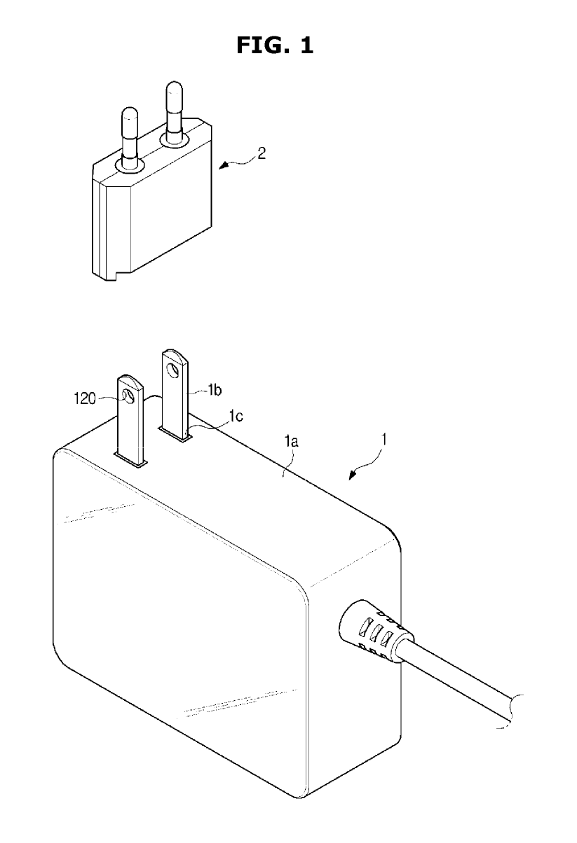

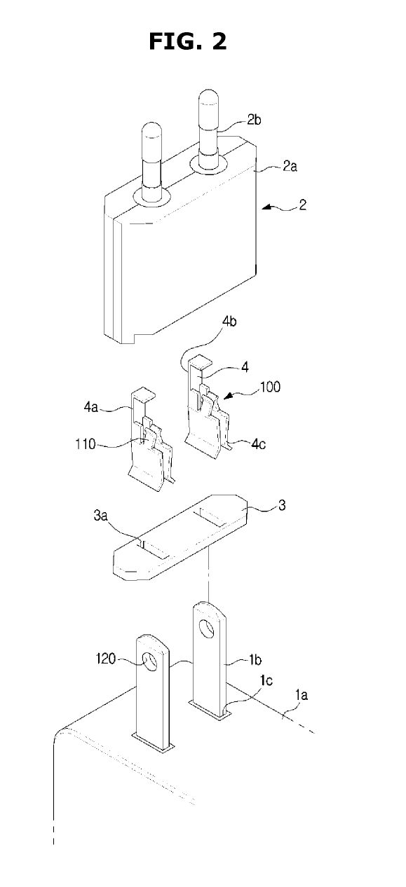

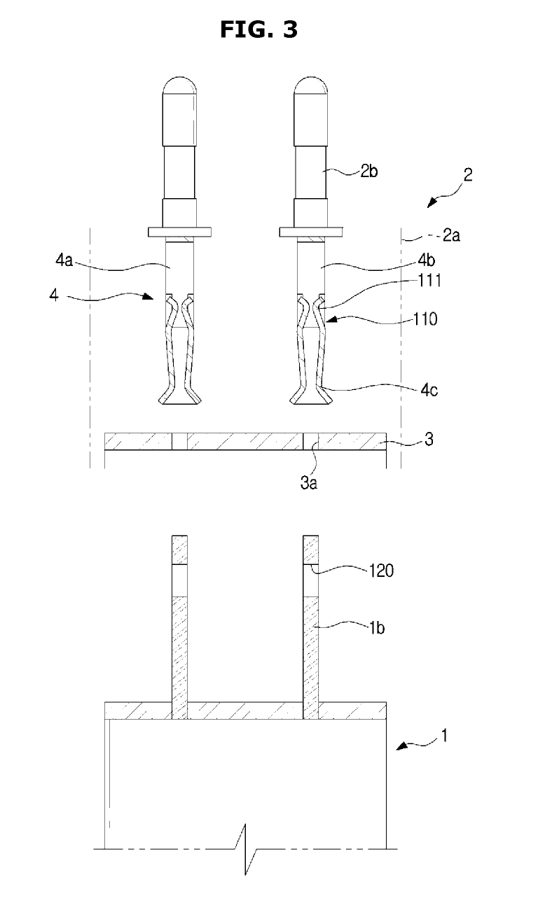

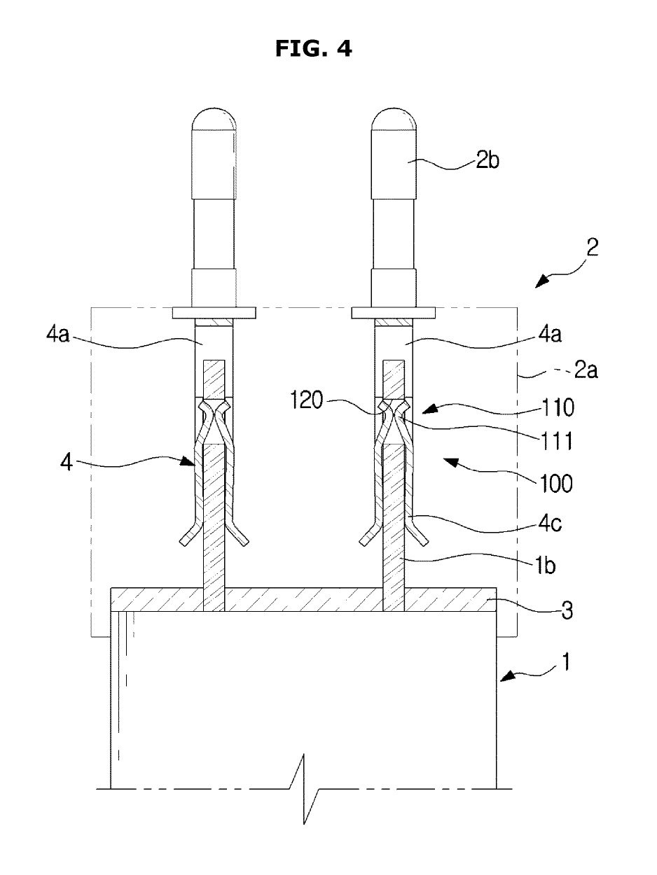

FIG. 1 is a view illustrating a plug and an adapter according to a first embodiment of the present disclosure. FIG. 2 is an exploded perspective view illustrating the plug detachably coupled to the adapter according to the first embodiment of the present disclosure. FIG. 3 is a partial cross-sectional view illustrating a locking structure between the plug and the adapter according to the first embodiment of the present disclosure. FIG. 4 is a view illustrating a locking structure between the plug and the adapter according to the first embodiment of the present disclosure.

Referring to FIGS. 1 to 4, the adapter 1 may include a main body 1a and connection pins 1b contained in the main body 1a.

Generally, an AC/DC adapter (hereinafter referred to as an adapter) designed to use any of two power-supply voltages 110V and 220V is used as a rectifier configured to convert a power-supply voltage of AC 110V/220V into a predetermined DC voltage. The above-mentioned adapter allows a user to selectively use the power-supply voltage of AC 110V or the power-supply voltage of AC 220V through switch conversion (not shown), such that one pair of 110V connection pins 1b configured to basically use the power-supply voltage of 110V protrudes from the main body 1a of the adapter 1.

The main body 1a of the adapter 1 may include an inner space in which a printed circuit board (PCB) (not shown) is installed, and the space may be formed in an approximately square shape. The main body 1a may include an insulation resin material, and may protect constituent elements contained in the inner space from the external part.

One pair of 110V-type connection pins 1b may be used in a manner that one 110V-type connection pin 1b is located to the left side and the other 110V-type connection pin 1b is located to the right side. The connection pins 1b may include a right connection pin located to the right side and a left connection pin located to the left side. The connection pins 1b may be connected to the PCB (not shown) contained in the main body 1a, such that the connection pins 1b may be electrically connected to each other.

The main body 1a may include one pair of through-holes 1c corresponding to the 110V-type connection pins 1b. The 110V-type connection pins 1b may protrude from the inside of the main body 1a through the through-holes 1c of the main body 1a.

In addition, the adapter 1 may include a plug 2 detachably coupled to the 110V-type connection pins 1b so as to use the 220V power-supply voltage.

In this case, the adapter 1 may be detachably coupled to the plug 2 by a locking structure 100.

The plug 2 may include a plug body 2a and one pair of plug pins 2b disposed at one side of the plug body 2a in a manner that the 220V power-supply voltage is used.

The plug body 2a may include an insulation material. A plug terminal 4 may be contained in the plug body 2a. The plug terminal 4 may be formed of a conductive material, and one pair of plug terminals 4 may be used in a manner that a left plug terminal and a right plug terminal are used.

The plug pins 2b may include a right pin disposed at the right side and a left pin disposed at the left side. The plug pins 2b exposed to the outside of the plug body 2a may be inserted into a socket (not shown) so as to receive a necessary power-supply voltage.

One end of the plug body 2a may be opened, and may include one pair of plug terminals 4 corresponding to the connection pins 1b of the adapter 1. One pair of plug terminals 4 may be arranged to correspond to the plug pins 2b.

A plug cover 3 may be coupled to the opening of the plug body 2a. The plug cover 3 may include insertion through-holes 3a in which the 110V-type connection pins 1b of the adapter 1 can be inserted. The insertion holes 3a may be formed in size and shape corresponding to the 110V-type connection pins 1b.

The locking structure 100 may include a first locking portion 110 disposed in the plug 2 and a second locking portion 120 disposed in the adapter 1 in a manner that the second locking portion 120 can be detachably coupled to the first locking portion 110.

The first locking portion 110 may be disposed in the plug terminal 4 contained in the plug 2. The plug terminal 4 may be electrically connected to the PCB (not shown) of the plug body 2a.

In addition, the plug terminal 4 may include a contact portion 4c configured to contact the connection pins 1b of the adapter 1 inserted into the plug body 2a through the insertion holes 3a.

The contact portion 4c of the plug terminal 4 may be formed in shape corresponding to the connection pins 1b. Although the contact portion 4c of the plug terminal 4 according to the embodiment is exemplarily formed in an approximately ‘ [symbol] ’ shape to enclose three sides of each connection pin 2b for convenience of description, the scope or spirit of the present disclosure is not limited thereto.

Meanwhile, the first locking portion 110 of the locking structure 100 may extend from the contact portion 4c of the plug terminal 4. The first locking portion 110 may be formed in an extended shape at the top of the plug terminal 4. The first locking portion 110 may extend from the top of the plug terminal 4, such that the first locking portion 110 can be elastically supported by the contact pins 2b. The first locking portion 110 may be formed in a manner that one pair of elastic pieces 111 facing each other can be elastically supported by the first locking portion 110. One pair of elastic pieces 111 of the first locking portion 110 may be elastically supported by the second locking portion 120 in a manner that the elastic pieces 111 can be detachably coupled to the second locking portion 120.

In this case, the second locking portion 120 may be formed in at least some parts of the connection pins 1b. The second locking portion 120 may be formed in each connection pin 1b. The second locking portion 120 may include at least one through hole formed in at least some parts of the top portion of each connection pin 1b. Although the embodiment has exemplarily disclosed that the second locking portion 120 is a hole formed in each connection pin 1b of the adapter 1 in a manner that the elastic pieces 111 of the first locking portion 110 can be combined with the second locking portion 120 for convenience of description, the scope or spirit of the present disclosure is not limited thereto. The second locking portion may include a groove through which each elastic piece can be detachably coupled thereto.

When the plug 2 is connected to the adapter 1, the plug 2 may be arranged to correspond to the connection pins 1b of the adapter 1, and may be connected to the insertion holes 3a formed in the cover 3 of the plug 2.

The connection pins 1b may be guided by the contact portion 4c of the internal terminal 4 of the plug body 2a.

In this case, the elastic piece 111 of the first locking portion 110 formed at the top of the contact portion 4c may be elastically supported by the connection pin 1b, move outward, and then move to the second locking portion 120 (i.e., the inside of each hole) of the connection pin 1b, such that the elastic piece 111 can be combined with the second locking portion 120. The plug 2 may be strongly combined with the connection pin 1b of the adapter 1 through the first locking portion 110 and the second locking portion 120.

In contrast, when the plug 2 is separated from the adapter 1, assuming that the plug 2 moves upward, the first locking portion 110 configured to elastically support the connection pin 1b may be released from the connection pin 1b and the plug 2 can be easily separated from the adapter 1.

Therefore, due to the presence of the locking structure 100, there is no risk of unexpected separation of the plug 2 and the adapter 1, and the plug 2 and the adapter 1 can be strongly fixed to each other through the locking structure 100.

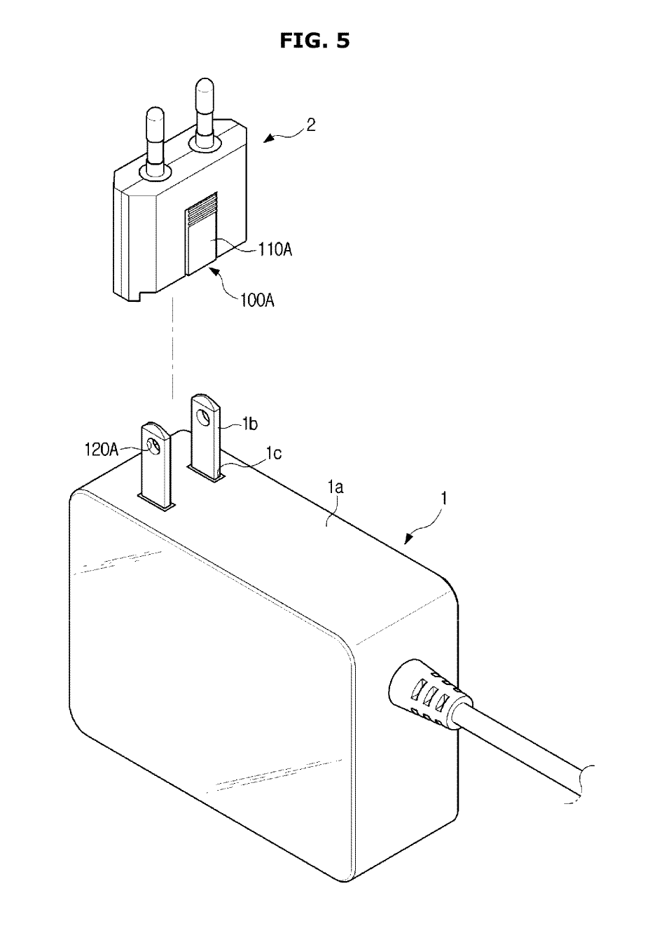

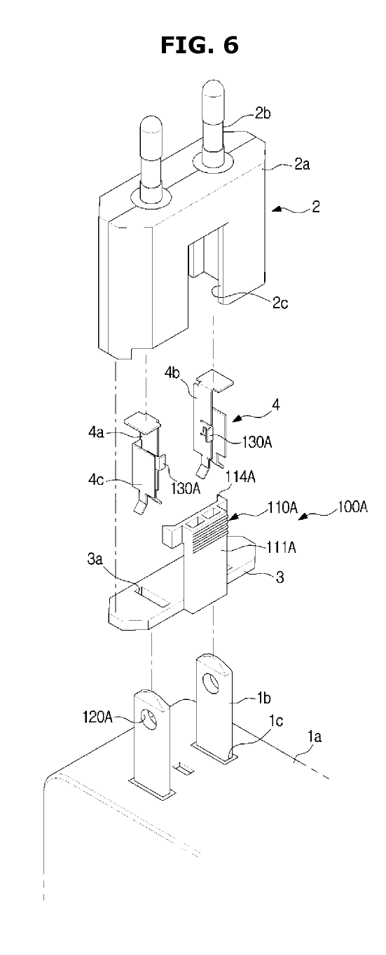

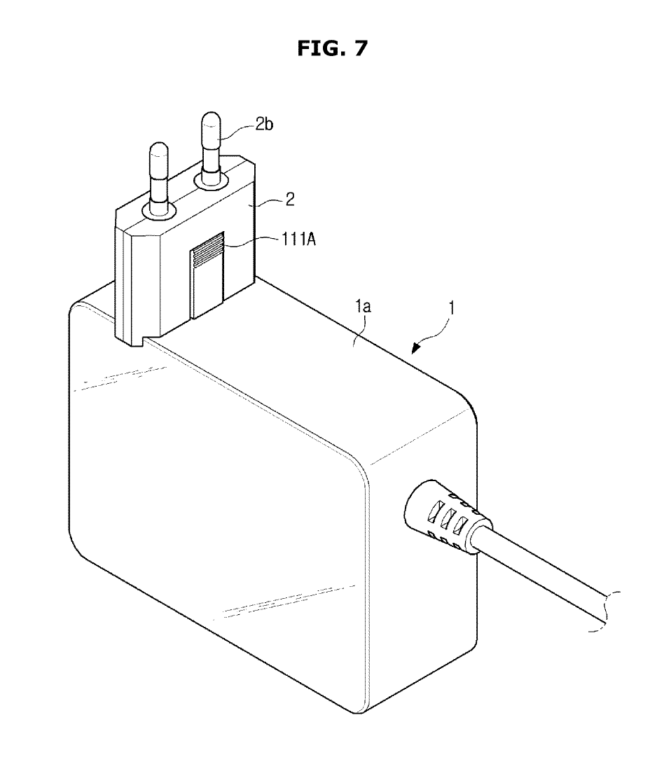

FIG. 5 is a view illustrating a plug and an adapter according to a second embodiment of the present disclosure. FIG. 6 is an exploded perspective view illustrating a locking structure for allowing the plug to be detachably coupled to the adapter according to the second embodiment of the present disclosure. FIG. 7 is a perspective view illustrating an adapter coupled to the plug according to the second embodiment of the present disclosure. The remaining reference numerals of the drawings will refer to those of FIGS. 1 to 4.

Referring to FIGS. 5 to 7, the adapter 1 may include a main body 1a and a connection pins 1b contained in the main body 1a.

Generally, the AC/DC adapter (hereinafter referred to as an adapter) designed to use any of two power-supply voltages 110V and 220V is used as a rectifier configured to convert a power-supply voltage of AC 110V/220V into a predetermined DC voltage. The above-mentioned adapter allows a user to selectively use the power-supply voltage of AC 110V or the power-supply voltage of AC 220V through switch conversion (not shown), such that one pair of 110V connection pins 1b configured to basically use the power-supply voltage of 110V protrudes from the main body 1a of the adapter 1.

The main body 1a of the adapter 1 may include an inner space in which a printed circuit board (PCB) (not shown) is installed, and the space may be formed in an approximately square shape. The main body 1a may include an insulation resin material, and may protect constituent elements contained in the inner space from the outside of the adapter 1.

One pair of 110V-type connection pins 1b may be used in a manner that one 110V-type connection pin 1b is located to the left side and the other 110V-type connection pin 1b is located to the right side. The connection pins 1b may include a right connection pin located to the right side and a left connection pin located to the left side. The connection pins 1b may be connected to the PCB (not shown) contained in the main body 1a, such that the connection pins 1b may be electrically connected to each other.

The main body 1a may include one pair of through-holes 1c corresponding to the 110V-type connection pins 1b. The 110V-type connection pins 1b may protrude from the inside of the main body 1a through the through-holes 1c of the main body 1a.

In addition, the adapter 1 may include a plug 2 detachably coupled to the 110V-type connection pins 1b so as to use the 220V power-supply voltage.

In this case, the adapter 1 may be detachably coupled to the plug 2 by a locking structure.

The plug 2 may include a plug body 2a and one pair of plug pins 2b disposed at one side of the plug body 2a in a manner that the 220V power-supply voltage is used.

The plug body 2a may include an insulation material. The plug terminal 4 may be formed of a conductive material, and one pair of plug terminals 4 may be used in a manner that a left plug terminal and a right plug terminal are used.

The plug body 2a may include an insulation material. A plug terminal 4 may be contained in the plug body 2a. The plug body 4 may be formed of a conductive material, and one pair of plug bodies 4 may be used in a manner that a left plug body and a right plug body are used.

The plug pins 2b may include a right pin disposed at the right side and a left pin disposed at the left side. The plug pins 2b exposed to the outside of the plug body 2a may be inserted into a socket (not shown) so as to receive a necessary power-supply voltage.

One end of the plug body 2a may be opened, and may include one pair of terminals 4 corresponding to the connection pins 1b of the adapter 1. One pair of terminals 4 may be arranged to correspond to the plug pins 2b.

A plug cover 3 may be coupled to the opening of the plug body 2a. The plug cover 3 may include insertion through-holes 3a in which the 110V-type connection pins 1b of the adapter 1 can be inserted. The insertion holes 3a may be formed in size and shape corresponding to the 110V-type connection pins 1b.

A locking structure 100A for allowing the plug cover 3 to be detachably coupled to the adapter 1 may be disposed in the plug cover 3 of the plug 2.

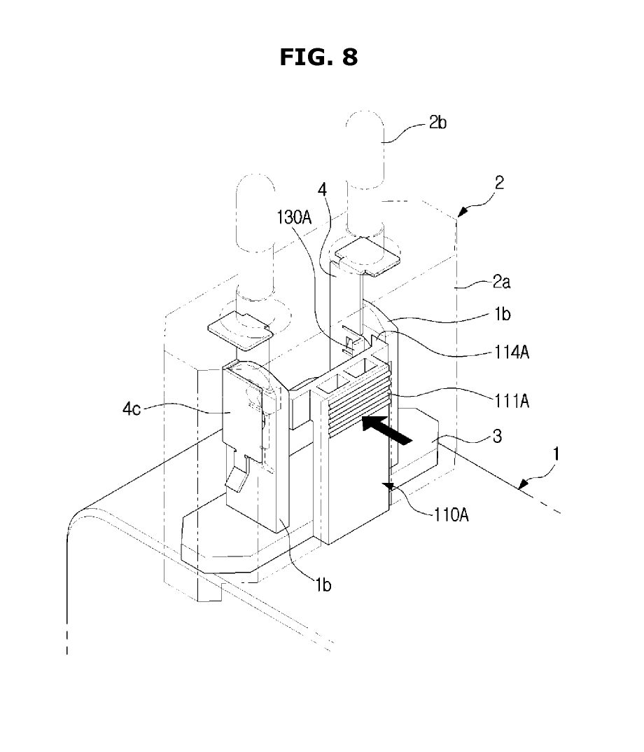

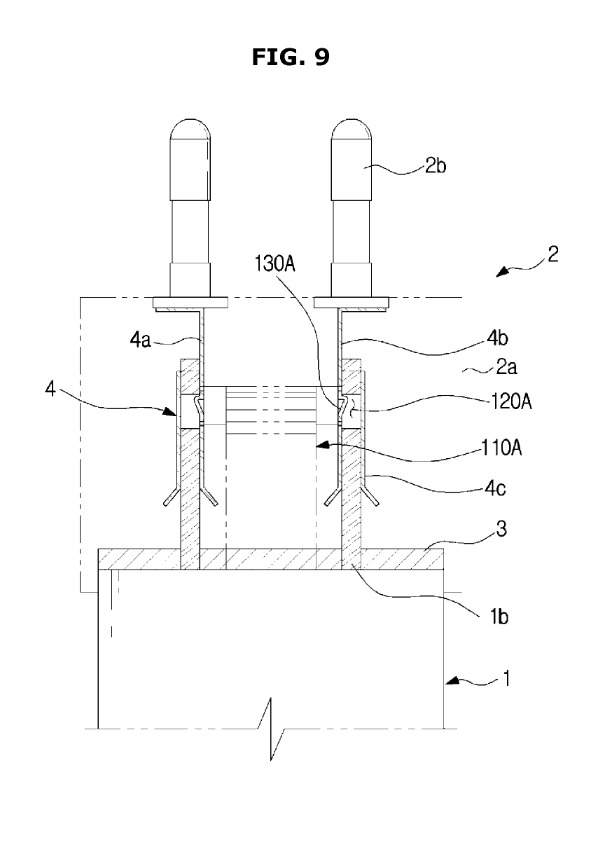

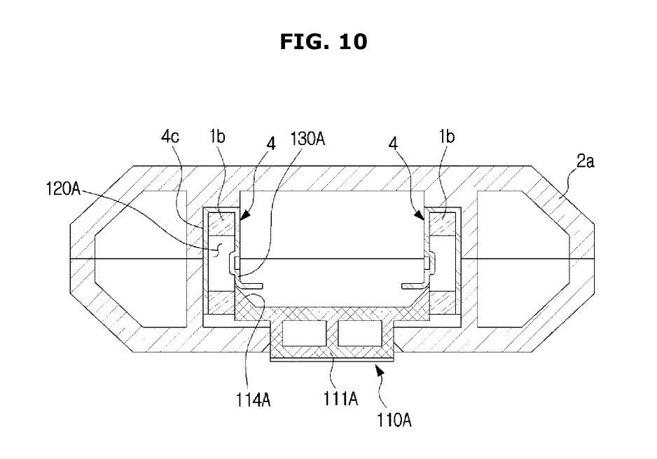

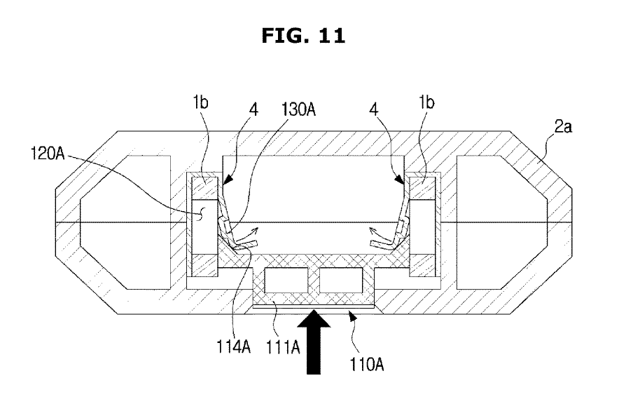

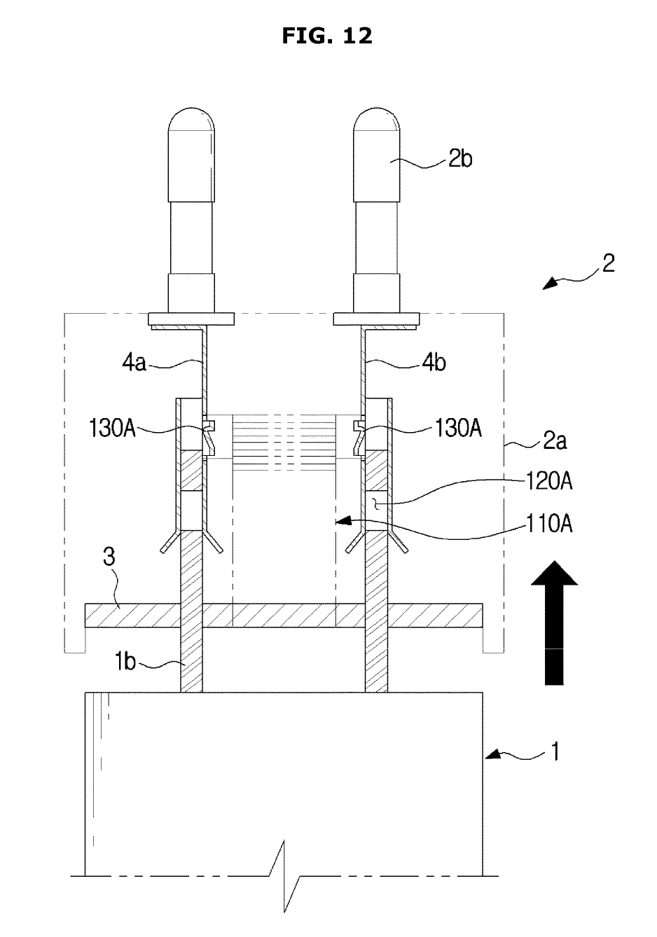

FIGS. 8 and 9 are views illustrating an adapter coupled to the plug by the locking structure according to the second embodiment of the present disclosure. FIG. 10 is a cross-sectional view illustrating the plug and adapter coupled to each other by the locking structure according to the second embodiment of the present disclosure. FIGS. 11 and 12 are views illustrating the plug separated from the adapter by the locking structure according to the second embodiment of the present disclosure. The remaining reference numerals of the drawings will refer to those of FIGS. 1 to 4.

Referring to FIGS. 8 to 12, the locking structure 100A may include a first locking portion 110A disposed in the plug body 2a of the plug 2, and a second locking portion 120A disposed in the adapter 1 in a manner that the second locking portion 120A can be detachably coupled to the first locking portion 110A.

The first locking portion 110A may be disposed in the plug cover 3. The first locking portion 110A may include a push button 111A provided in the plug cover 3. The first locking portion 110A may be curved from one end of the plug cover 3. The first locking portion 110A may be formed at one surface of the plug body 2a such that the first locking portion 110A can move to the inside of the plug 2.

The plug body 2a may include an installation hole 2c formed in a cut shape such that the first locking portion 110A can move through the installation hole 2c. The installation hole 2c of the plug body 2a may be formed in size and shape corresponding to the push button 111A of the first locking portion 110A.

The first locking portion 110A may further include a pressing portion 114A having an inclined surface along which the pressing portion 114A moves by the push button 111A. The pressing portion 114A may move a moving portion 130A formed in the terminal 4 of the adapter 1, such that the terminal 4 can be separated from the connection pin 1b of the adapter 1.

In this case, the second locking portion 120A to be coupled to the terminal 4 may be formed at a predetermined position of the upper portion of the connection pin 1b. Although the embodiment has exemplarily disclosed that the second locking portion 120A is implemented as a hole formed in the connection pin 1a of the adapter 1 in such a manner that the terminal 4 of the plug 2 can be inserted into the hole for convenience of description, the scope or spirit of the present disclosure is not limited thereto.

In order to separate the plug 2 from the adapter 1, assuming that a user presses the push button 111A of the plug body 2a, the moving portion 130A of the terminal 4 is pressed by the pressing portion 114A of the push button 111A, such that the moving portion 130A of the terminal 4 moves to the center portion of the plug body 2a, and the terminal 4 is separated from the second locking portion 120A formed in the connection pin 1b of the adapter 1 through movement of the moving portion 130A.

If the connection pin 1b of the adapter 1 is separated from the terminal 4 of the plug 2, the plug 2 moves to the outside of the adapter 1 such that the plug 2 can be separated from the adapter 1.

Therefore, due to the presence of the locking structure 100A, there is no risk of unexpected separation of the plug 2 and the adapter 1, and the plug 2 and the adapter 1 can be strongly fixed to each other through the locking structure 100A.

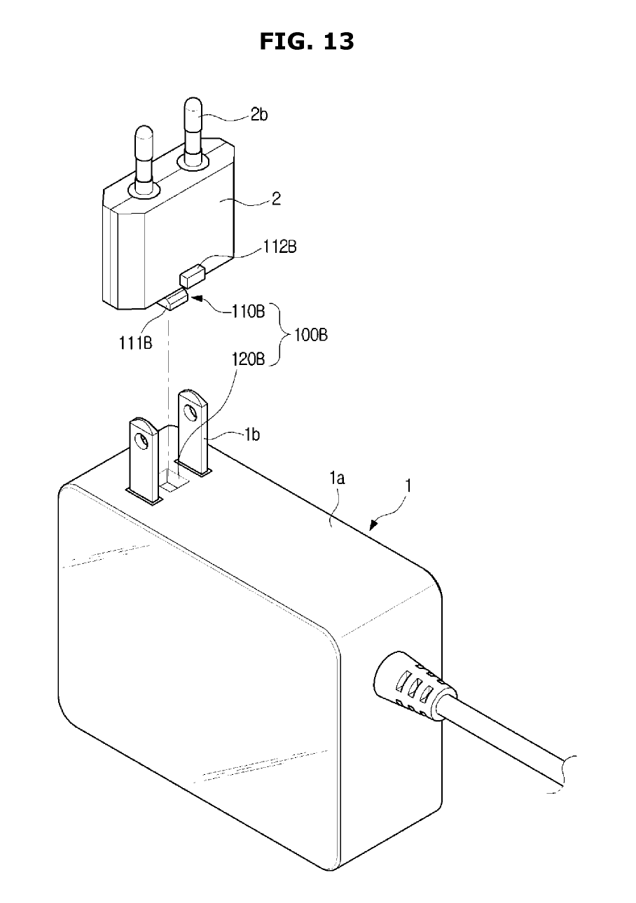

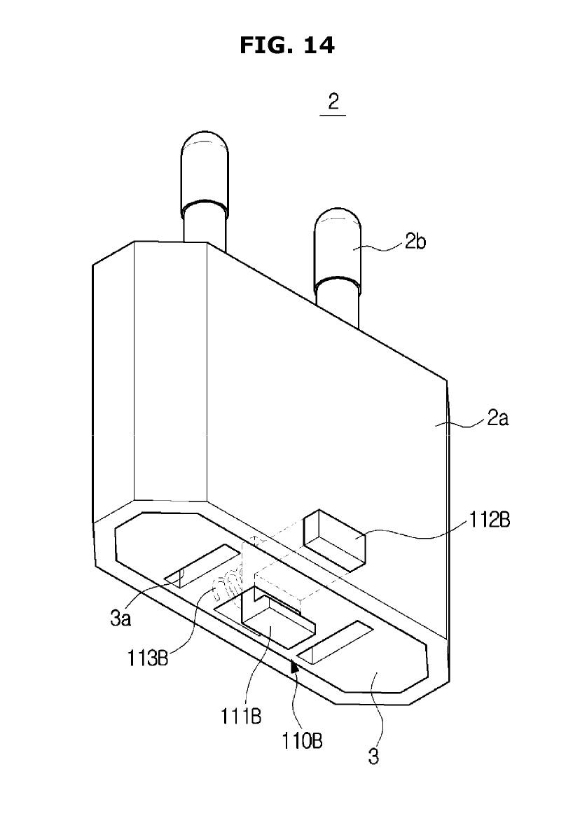

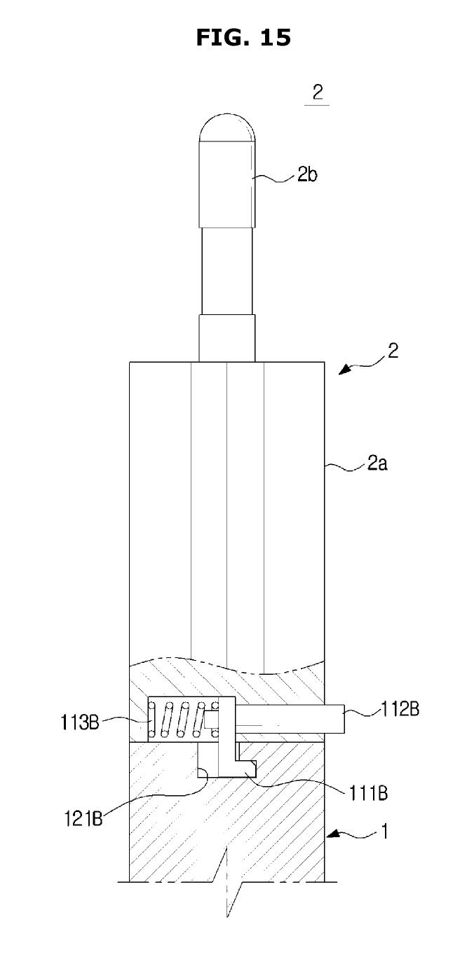

FIG. 13 is a view illustrating a locking structure between the plug and the adapter according to a third embodiment of the present disclosure. FIG. 14 is a perspective view illustrating a first locking portion of the plug according to the third embodiment of the present disclosure. FIG. 15 is a view illustrating connection between the first locking portion and the second locking portion of the locking structure according to the third embodiment of the present disclosure. The remaining reference numerals of the drawings will refer to those of FIGS. 1 to 4.

Referring to FIGS. 13 to 15, the locking structure 100B for allowing the plug 2 to be detachably coupled to the adapter 1 may include a first locking portion 1108 disposed in the plug 2 and a second locking portion 120B disposed in the adapter 1.

The plug 2 may include a plug body 2a and a plug cover 3.

A lower end of the plug body 2a may be opened, and a plug cover 3 may be disposed in the opened lower end. The plug cover 3 may include insertion holes 3a, each of which is formed in shape corresponding to the connection pin 1b of the adapter 1.

The first locking portion 1108 may be disposed in the plug body 2a. The first locking portion 1108 may include a button 112B configured to move from the outside to the inside of the plug body 2a, and an elastic portion 113B configured to elastically support the button 112B. The button 112B may be exposed to the outside of the plug body 2a, such that the button 1128 may move inward when being pressed by the user. At least some parts of the button 112B may be exposed to the outside of the plug body 2a through a slit formed in the plug body 2a.

The button 112B exposed to the outside of the plug body 2a may be pressed by the user so that the button 112B may move to the inside of the plug body 2a.

The button 112B may further include a protrusion 111B extending from the rear end to the lower end thereof. The protrusion 111B may be detachably coupled to the second locking portion 120B formed in the adapter 1.

The protrusion 111B of the button 112B may protrude downward at the center part of the plug cover 3.

Meanwhile, the second locking portion 120B may be formed in size and shape corresponding to the button 112B of the first locking portion 110B. The second locking portion 120B may be disposed in the main body 1a of the adapter 1. The second locking portion 120B may be disposed between the connection pins 1b of the adapter 1. The second locking portion 120B may include a groove 121B in which the protrusion 111B is inserted, and the groove 121B may protrude from the lower end of the button 112B.

Therefore, the connection pins 1b of the adapter 1 are respectively inserted into the insertion holes 3a of the plug 2, and at the same time the first locking portion 110B is coupled and fixed to the second locking portion 120B. When the adapter 1 is separated from the plug 2, the button 112B of the first locking portion 110B of the plug 2 is pressed so that the button 112B is separated from the groove 121B of the second locking portion 120B.

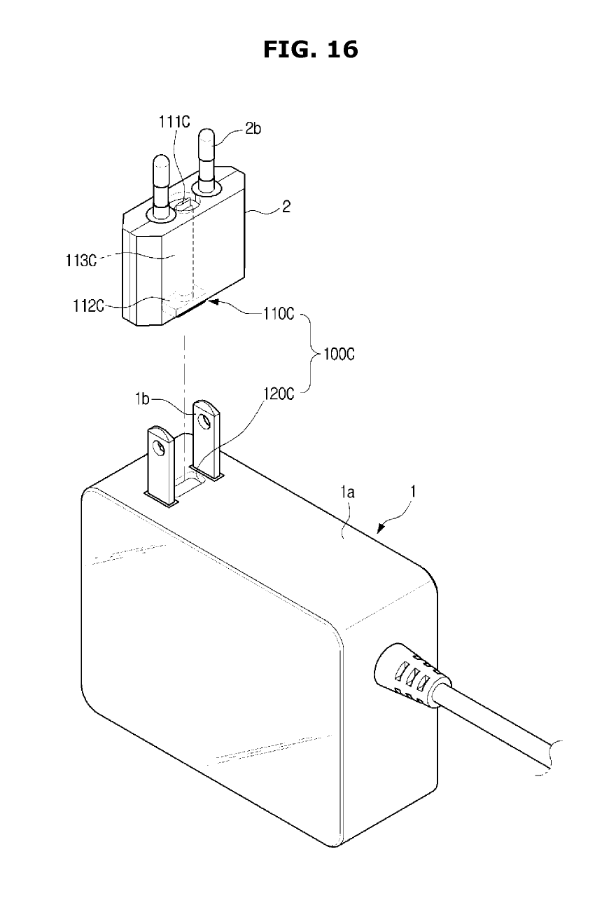

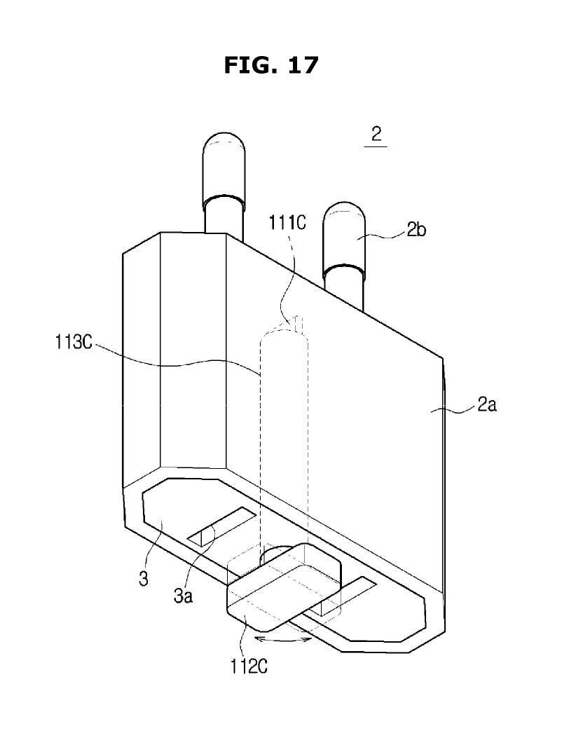

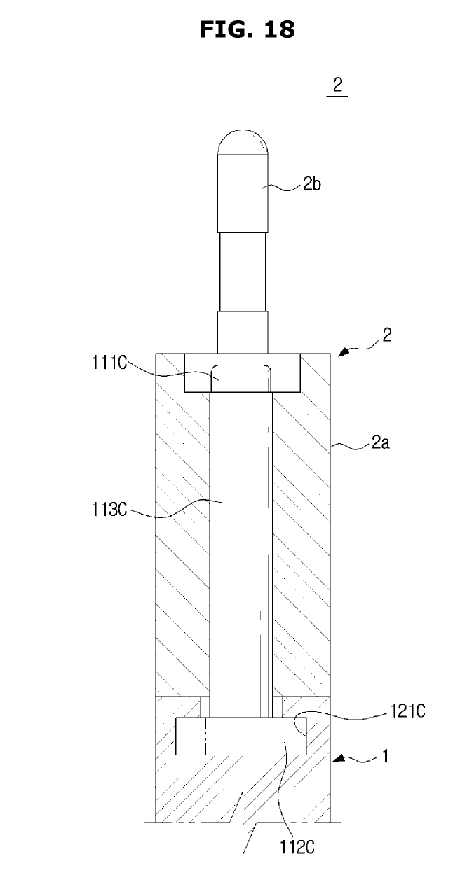

FIG. 16 is a view illustrating a locking structure according to a fourth embodiment of the present disclosure. FIG. 17 is a view illustrating a first locking portion of the locking structure according to the fourth embodiment of the present disclosure. FIG. 18 is a view illustrating connection between the first locking portion and the second locking portion of the locking structure according to the fourth embodiment of the present disclosure. The remaining reference numerals of the drawings will refer to those of FIGS. 1 to 4.

Referring to FIGS. 16 to 18, the locking structure 100C for allowing the plug 2 to be detachably coupled to the adapter 1 may include a first locking portion 110C disposed in the plug 2 and a second locking portion 120C disposed in the adapter 1.

The first locking portion 110C may be disposed in the plug 2. The first locking portion 110C may include a cylindrical rotation bar 113C located at the center part of the plug body 2a in a manner that the cylindrical rotation bar 113C can pass through the center part of the plug body 2a in a downward direction.

A rotation knob 111C selectively rotated by the user may be provided at the upper end of the rotation bar 113C, and a rotation protrusion 112C configured to rotate by the rotation knob 111C may be provided at the bottom of the rotation bar 113C.

The first locking portion 110C may be disposed at the center part located between the installation holes 3a of the plug cover 3.

The second locking portion 120C may be formed in size and shape corresponding to the rotation protrusion 112C in the first locking portion 110C. The second locking portion 120C may be disposed in the main body 1a of the adapter 1. The second locking portion 120C may be disposed between the connection pins 1b of the adapter 1. The second locking portion 120C may include a groove 121C in which the rotation protrusion 112C is inserted and rotates therein.

Therefore, the connection pins 1b of the adapter 1 are inserted into the insertion holes 3a of the plug 2 and at the same time the first locking portion 110C is coupled to the second locking portion 120C, such that the plug 2 can be coupled to the adapter 1. In this case, the rotation protrusion 112C of the first locking portion 110C may be identical in shape to the groove 121C of the second locking portion 120C.

In order to fix the plug 2 and the adapter 1, the user rotates the rotation knob 111C of the first locking portion 110C in a manner that the rotation protrusion 112C may be arranged to deviate from the groove 121C of the second locking portion 120C, such that the plug 2 can be coupled and fixed to the adapter 1. In order to separate the plug 2 from the adapter 1, the user rotates the rotation knob 111C of the first locking portion 110C such that the rotation protrusion 112C is formed in shape corresponding to the groove 121C of the second locking portion 120C and is thus separated from the groove 121C of the second locking portion 120C as necessary.

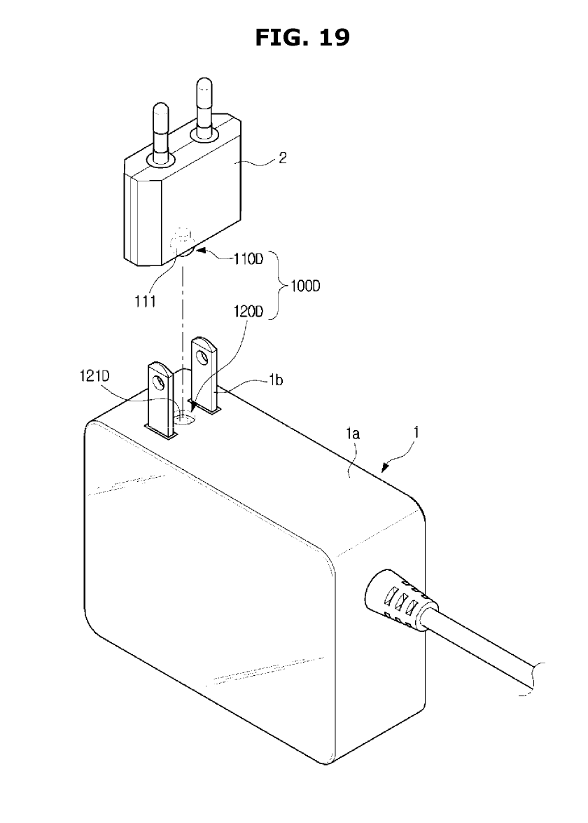

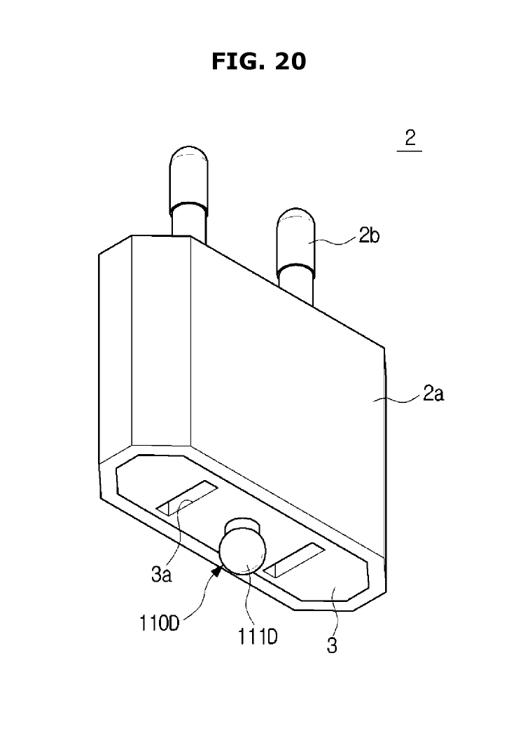

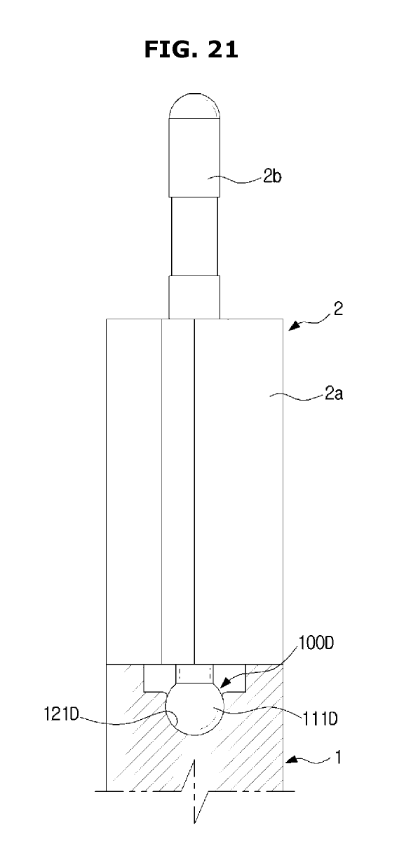

FIG. 19 is a view illustrating a locking structure according to a fifth embodiment of the present disclosure. FIG. 20 is a view illustrating a first locking portion of the locking structure according to the fifth embodiment of the present disclosure. FIG. 21 is a view illustrating connection between the first locking portion and the second locking portion of the locking structure according to the fifth embodiment of the present disclosure. The remaining reference numerals of the drawings will refer to those of FIGS. 1 to 4.

Referring to FIGS. 19 to 21, the locking structure 100D for allowing the plug 2 to be detachably coupled to the adapter 1 may include a first locking portion 110D disposed in the plug 2 and a second locking portion 120D disposed in the adapter 1.

The first locking portion 110D may be disposed in the plug cover 3 coupled to the lower end of the plug 2. The first locking portion 110D may include a spherical protrusion 111D protruding downward at the center part of the plug cover 3.

The first locking portion 110D may be disposed at the center part located between the installation holes 3a of the plug cover 3.

The second locking portion 120D may be formed in size and shape corresponding to the first locking portion 110D. The second locking portion 120D may be disposed in the main body 1a of the adapter 1. The second locking portion 120D may be disposed between the connection pins 1b of the adapter 1. The second locking portion 120D may include a spherical groove 121D in which the spherical protrusion 111D is inserted.

Therefore, the connection pins 1b of the adapter 1 are inserted into the insertion holes 3a of the plug 2, and at the same time the first locking portion 110D can be coupled to the second locking portion 120D.

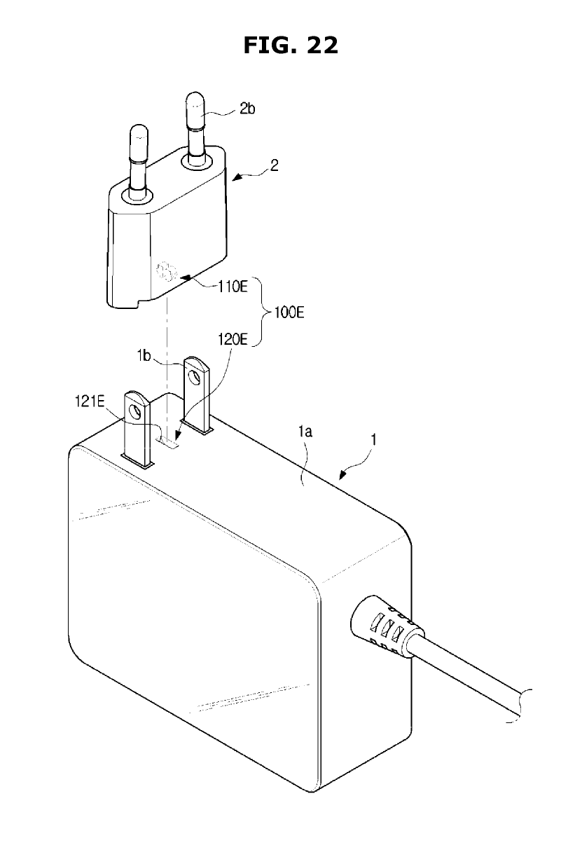

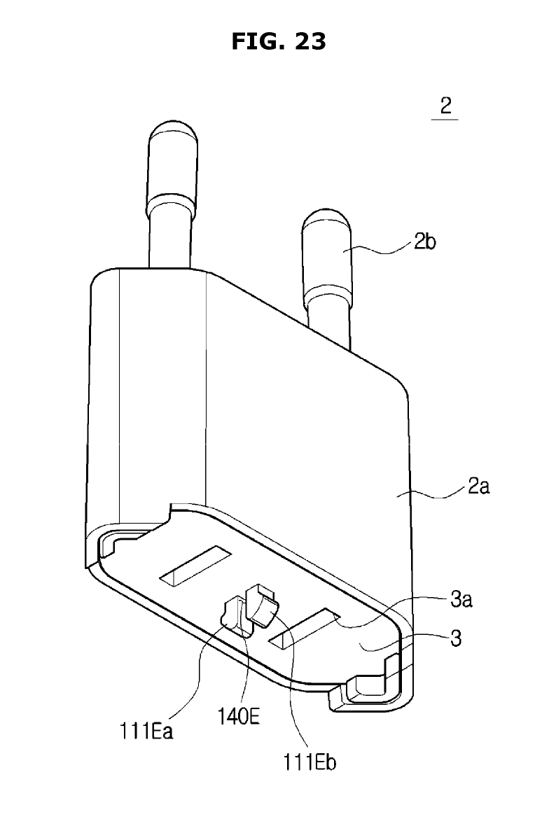

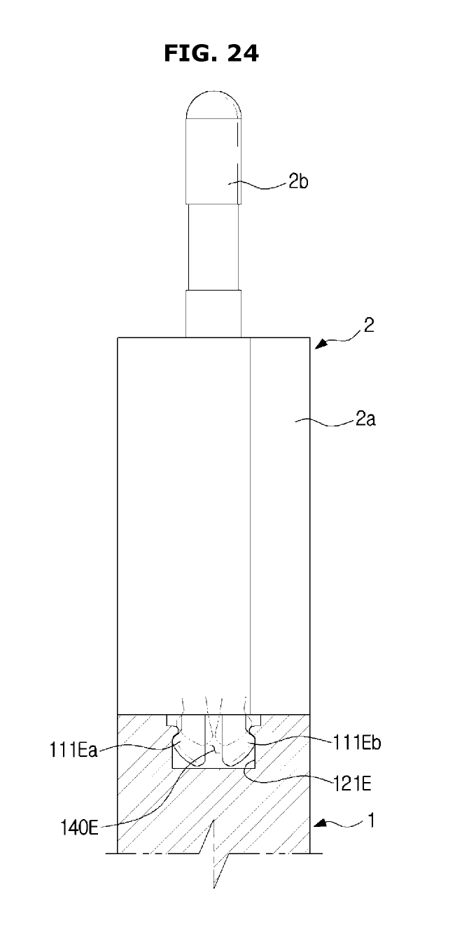

FIG. 22 is a view illustrating a locking structure according to a sixth embodiment of the present disclosure. FIG. 23 is a view illustrating a first locking portion of the locking structure according to the sixth embodiment of the present disclosure. FIG. 24 is a view illustrating connection between the first locking portion and the second locking portion of the locking structure according to the sixth embodiment of the present disclosure. The remaining reference numerals of the drawings will refer to those of FIGS. 1 to 4.

Referring to FIGS. 22 to 24, the locking structure 100E for allowing the plug 2 to be detachably coupled to the adapter 1 may include a first locking portion 110E disposed in the plug 2 and a second locking portion 120E disposed in the adapter 1.

The first locking portion 110E may be disposed in the plug cover 3 coupled to the lower end of the plug 2. The first locking portion 110E may include hook-shaped protrusions protruding downward at the center part of the plug cover 3.

The first locking portion 110E may include a separation portion 140E passing through the center part of the hook-shaped protrusions. The hook-shaped protrusions may be arranged to face each other on the basis of the separation portion 140E. The hook-shaped protrusions may include a first protrusion 111Ea disposed at one side on the basis of the separation portion 140E, and a second protrusion 111Eb arranged to face the first protrusion 111Ea.

The first protrusion 111Ea and the second protrusion 111Eb may be formed to elastically move through the separation portion 140E.

The first locking portion 110E may be disposed between the installation holes 3a of the plug cover 3.

The second locking portion 120E may be formed in size and shape corresponding to the first locking portion 110E. The second locking portion 120E may be disposed in the main body 1a of the adapter 1. The second locking portion 120E may be disposed between the connection pins 1b of the adapter 1. The second locking portion 120E may include a groove 121E formed in size and shape in a manner that the hook-shaped protrusions can be inserted into the groove 121E.

Meanwhile, the connection pins 1b of the adapter 1 are inserted into the insertion holes 3a of the plug 2, and at the same time the first locking portion 110E can be coupled to the second locking portion 120E.

When the first locking portion 110E is inserted into the groove 121E of the second locking portion 120E, the first protrusion 111Ea and the second protrusion 111Eb move toward the separation portion 140E, such that the first protrusion 111Ea and the second protrusion 111Eb may elastically return to original positions thereof after completion of insertion.

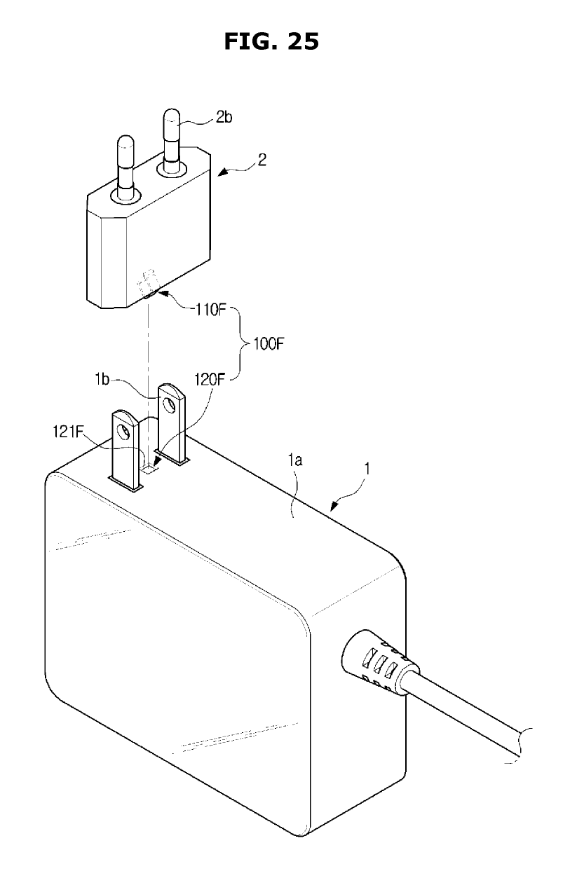

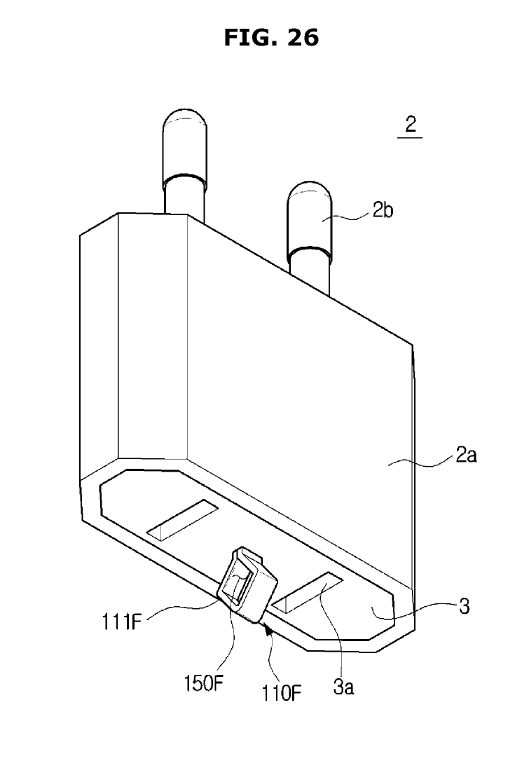

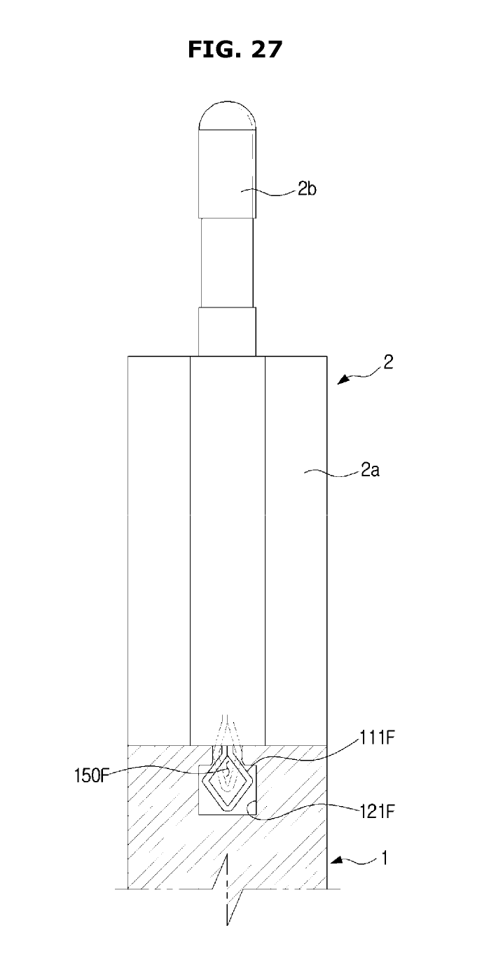

FIG. 25 is a view illustrating a locking structure according to a seventh embodiment of the present disclosure. FIG. 26 is a view illustrating a first locking portion of the locking structure according to the seventh embodiment of the present disclosure. FIG. 27 is a view illustrating connection between the first locking portion and the second locking portion of the locking structure according to the seventh embodiment of the present disclosure.

Referring to FIGS. 25 to 27, the locking structure 100F for allowing the plug 2 to be detachably coupled to the adapter 1 may include a first locking portion 110F disposed in the plug 2 and a second locking portion 120F disposed in the adapter 1.

The first locking portion 110F may be disposed in the plug cover 3 coupled to the lower end of the plug 2. The first locking portion 110F may include a diamond-shaped protrusion 111 F protruding downward at the center part of the plug cover 3.

The diamond-shaped protrusion 111F may include an elastic support hole 150F passing through the center part of the plug 2. The diamond-shaped protrusion 111 F may elastically move by the elastic support hole 150F located at the center part of the plug 2. The first locking portion 110F may be arranged at the center part t located between the installation holes 3a of the plug cover 3.

The second locking portion 120F may be formed in size and shape corresponding to the first locking portion 110F. The second locking portion 120F may be disposed in the main body 1a of the adapter 1. The second locking portion 120F may be disposed between the connection pins 1b of the adapter 1. The second locking portion 120F may include a groove 121F in which the diamond-shaped protrusion 111F is inserted.

Meanwhile, the connection pins 1b of the adapter 1 are inserted into the insertion holes 3a of the plug 3a, and at the same time the first locking portion 110F can be combined with the second locking portion 120F.

When the first locking portion 110F is inserted into the groove 121F of the second locking portion 120F, the diamond-shaped protrusion 111F may move toward the center part by the elastic support hole 150F, such that the diamond-shaped protrusion 111F may elastically return to the original position thereof after completion of insertion.

As is apparent from the above description, the adapter assembly according to the embodiment can allow the plug and the adapter to be detachably coupled to each other through a locking structure, resulting in greater user convenience.

The adapter assembly according to the embodiments can prevent disconnection between the adapter and the plug using a simple structure, and can strongly interconnect the adapter and the plug, resulting in increased stability and reliability.

Although a few embodiments of the present disclosure have been shown and described, it would be appreciated by those skilled in the art that changes may be made in these embodiments without departing from the principles and spirit of the present disclosure, the scope of which is defined in the claims and their equivalents.

What is claimed is:

1. An adapter assembly comprising:
an adapter configured to include connection pins;
a plug configured to include a terminal contacting the connection pins; and
a locking structure through which the plug and the adapter are detachably fixed to each other.

2. The adapter assembly according to claim 1, wherein the locking structure includes:
a first locking portion disposed in the plug; and
a second locking portion disposed in the adapter and detachably coupled to the first locking portion.

3. The adapter assembly according to claim 2, wherein the second locking portion includes:
a through hole disposed in at least one of the connection pins.

4. The adapter assembly according to claim 2, wherein the first locking portion includes:
an elastic piece disposed in the terminal and configured to generate elastic force when the connection pins move in a manner that the elastic piece is coupled to a groove.

5. The adapter assembly according to claim 2, wherein the first locking portion includes:
a button portion disposed in the plug; and
a moving portion configured to move by the button portion so that the moving portion is coupled to or separated from the connection pins.

6. The adapter assembly according to claim 2, wherein the first locking portion includes:
a rotation bar configured to rotate by the plug; and
a rotation protrusion coupled to or separated from the adapter by rotation of the rotation bar.

7. The adapter assembly according to claim 2, wherein:
the first locking portion includes a protrusion protruding from a bottom surface of the plug; and
the protrusion includes at least one of a spherical shape, a diamond shape, a square shape, a triangular shape, and a semicircular shape.

8. The adapter assembly according to claim 7, wherein the second locking portion includes a groove formed in a shape corresponding to the protrusion.

9. The adapter assembly according to claim 7, wherein the first locking portion includes:
a separation portion disposed in a center part of the protrusion in a manner that the first locking portion is elastically coupled to the second locking portion.

10. An adapter assembly comprising:
a plug;
an adapter main body in which connection pins coupled to the plug are disposed; and
a locking structure through which the plug and the adapter are detachably coupled to each other,
wherein the locking structure includes:
a first locking portion disposed in the plug; and
a second locking portion disposed in at least one of the adapter main body and the connection pins in a manner that the second locking portion is fixed and separated by the first locking portion.

11. The adapter assembly according to claim 10, wherein the second locking portion includes:
a through hole disposed in at least one of the connection pins.

12. The adapter assembly according to claim 10, wherein the first locking portion includes:
an elastic piece disposed in the terminal and configured to generate elastic force when the connection pins move in a manner that the elastic piece is coupled to a groove.

13. The adapter assembly according to claim 10, wherein the first locking portion includes:
a button portion disposed in the plug; and
a moving portion configured to move by the button portion so that the moving portion is coupled to or separated from the connection pins.

14. The adapter assembly according to claim 10, wherein the first locking portion includes:
a rotation bar configured to rotate by the plug; and
a rotation protrusion coupled to or separated from the adapter by rotation of the rotation bar.

15. The adapter assembly according to claim 10, wherein:
the first locking portion includes a protrusion protruding from the plug; and
the protrusion includes at least one of a spherical shape, a diamond shape, a square shape, a triangular shape, and a semicircular shape.

16. The adapter assembly according to claim 15, wherein the second locking portion includes a groove formed in a shape corresponding to the protrusion.

17. The adapter assembly according to claim 15, wherein the first locking portion includes:
a separation portion disposed in a center part of the protrusion in a manner that the first locking portion is elastically coupled to the second locking portion.

18. The adapter assembly according to claim 15, wherein the first locking portion further includes an elastic support hole passing through the protrusion.
